(19) United States
(12) Patent Application Publication
(10) Pub. No.: US 2026/0236154 A1
(43) Pub. Date: Aug. 13, 2026

(54) Agentic AI Interactive Canvas

(71) Applicant: ServiceNow, Inc., Santa Clara, CA (US)

(72) Inventors: Laura Ashley Coburn, San Diego, CA (US); Amanda Kierstead Poray, San Francisco, CA (US); Douglas Steele Lorn Bradley, San Diego, CA (US); Hayley Jean Mortin, Montreal (CA); Paige Michelle Camerino, Boulder Creek, CA (US); Jessa Kelsey Anderson, San Diego, CA (US)

(21) Appl. No.: 19/047,862

(22) Filed: Feb. 7, 2025

(51) Int. Cl. G06F 3/04847; G06F 9/451

(52) U.S. Cl. CPC G06F 3/04847; G06F 9/451

(57) ABSTRACT

A method includes obtaining a use case that includes a task and identifying a multi-agent system for performing the task. The method includes generating a graphical representation of the multi-agent system. The graphical representation includes relational indicators regarding the multi-agent system. The method includes obtaining an input interaction that is directed to the graphical representation of the multi-agent system and updating the graphical representation based on the input interaction.

### TECHNICAL FIELD

This disclosure relates to an interactive canvas.

### BACKGROUND

The integration of artificial intelligence (AI) into various technological applications has seen significant advancements in recent years. One of the key developments in AI technology is the use of multi-agent systems. A multi-agent system includes multiple interacting agents that work collaboratively to achieve specific goals or perform complex tasks that a single agent may be unable to handle alone. The collaborative nature of the multi-agent system allows for the distribution of tasks, parallel processing, and the ability to tackle problems from multiple perspectives. However, designing a multi-agent system presents several challenges. One of the main challenges is a lack of understanding of the interactions and relationships among the various agents within the multi-agent system.

### SUMMARY

One implementation of the disclosure provides a computer-implemented method of updating a multi-agent system. The method includes obtaining a use case including a task and identifying a multi-agent system for performing the task. The method includes generating a graphical representation of the multi-agent system. The graphical representation includes relational indicators regarding the multi-agent system. The method includes obtaining an input interaction that is directed to the graphical representation of the multi-agent system and updating the graphical representation based on the input interaction.

Implementations of the disclosure may include one or more of the following optional features. In some implementations, the use case is associated with one or more artificial intelligence (AI) agents where each respective AI agent is associated with a respective one or more tools. In these implementations, each respective AI agent includes a name of the respective AI agent, a description of the respective AI agent, and instructions guiding the respective AI agent to perform a respective portion of the task. Here, the relational indicators may represent relationships among the use case and the one or more AI agents. In these implementations, for each respective AI agent, the relational indicators represent relationships between the respective AI agent and the respective one or more tools associated with the respective AI agent.

In some examples, the input interaction includes a modified task associated with the use case for the multi-agent system to perform. In these examples, the method may further include updating the multi-agent system to include an additional AI agent to perform the modified task based on the input interaction. Here, the method may further include deploying the updated multi-agent system, obtaining a prompt, and performing an action based on the prompt using the updated multi-agent system. Updating the multi-agent system to include the additional AI agent to perform the modified task may include determining that the additional AI agent to perform the modified task exists in a database of AI agents and adding the additional AI agent to the multi-agent system based on determining that the additional AI agent to perform the modified task exists in the database of AI agents. Here, determining that the additional AI agent to perform the modified task exists in the database of AI agents may include determining a similarity threshold is satisfied between the modified task and a description of the additional AI agent. In these examples, updating the multi-agent system to include the additional AI agent to perform the modified task may include determining that the additional AI agent to perform the modified task does not exist in a database of AI agents, generating the additional AI agent to perform the modified task based on determining that the additional AI agent to perform the modified task does not exist in the database of AI agents, and adding the additional AI agent to the multi-agent system.

In some implementations, the method further includes receiving a natural language prompt describing the task. In these implementations, obtaining the use case may include obtaining the use base based on the natural language prompt. The use case may include a name of the use case and a description of the use case. In some examples, the method further includes transmitting the updated graphical representation to a user device. Here, the updated graphical representation, when received by the user device, is configured to cause a graphical user interface (GUI) of the user device to display the updated graphical representation. In some implementations, the input interaction includes at least one of a rearrangement of the multi-agent system or a zoom modification of the graphical representation.

Another implementation of the disclosure provides a system that includes data processing hardware and memory hardware storing instructions that when executed on the data processing hardware causes the data processing hardware to perform operations. The operations include obtaining a use case that includes a task and identifying a multi-agent system for performing the task. The operations include generating a graphical representation of the multi-agent system. The graphical representation includes relational indicators regarding the multi-agent system. The operations include obtaining an input interaction that is directed to the graphical representation of the multi-agent system and updating the graphical representation based on the input interaction.

Implementations of the disclosure may include one or more of the following optional features. In some implementations, the use case is associated with one or more artificial intelligence (AI) agents where each respective AI agent is associated with a respective one or more tools.

Another implementation of the disclosure provides a computer-readable medium having instructions that, when executed by data processing hardware, causes the data processing hardware to perform operations. The operations include obtaining a use case that includes a task and identifying a multi-agent system for performing the task. The operations include generating a graphical representation of the multi-agent system. The graphical representation includes relational indicators regarding the multi-agent system. The operations include obtaining an input interaction that is directed to the graphical representation of the multi-agent system and updating the graphical representation based on the input interaction.

The details of one or more implementations of the disclosure are set forth in the accompanying drawings and the description below. Other implementations, features, and advantages will be apparent from the description and drawings, and from the claims.

### DESCRIPTION OF DRAWINGS

FIG. 1 is a schematic view of an example system using a controller to update a graphical representation of a multi-agent system.

FIGS. 2A-C are schematic views of example graphical representations of the multi-agent system.

FIGS. 3A-D are schematic views of example updated graphical representations of the multi-agent system.

FIG. 4 is a schematic view of a user interface that generates a multi-agent system from a natural language input.

FIG. 5 is a flowchart of an example arrangement of operations for a computer-implemented method of updating a multi-agent system.

FIG. 6 is a schematic view of an example computing device that may be used to implement the systems and methods described herein.

Like reference symbols in the various drawings indicate like elements.

### DETAILED DESCRIPTION

In recent years, the integration of artificial intelligence (AI) into a wide array of technological applications has experienced remarkable progress. Among the developments in AI technology is the emergence and utilization of multi-agent systems. A multi-agent system includes multiple interacting agents, each designed to work collaboratively towards achieving specific objectives or performing intricate tasks that would be beyond the capacity of a single agent. The multi-agent system leverages the collective intelligence and capabilities of its constituent agents, enabling the distribution of tasks and parallel processing. This collaborative framework not only enhances the efficiency of the system but also allows the system to approach problems from diverse perspectives, thereby increasing the robustness and adaptability of the solutions generated. The agents within a multi-agent system can be homogeneous, performing similar functions, or heterogeneous, with each agent specializing in different tasks. The diversity in agent roles further enriches the problem-solving potential of the multi-agent system.

However, designing a multi-agent system presents many challenges. One of the primary challenges is understanding and managing the complex interactions and relationships among the various agents. These interactions can be cooperative, competitive, or a mix of both, depending on the goal of the system and the nature of the task at hand. Effective coordination and communication among agents are important to ensure that the system functions harmoniously and efficiently. Moreover, the dynamic nature of the multi-agent system necessitates the development of sophisticated algorithms and protocols to handle agent behaviors, decision-making processes, and conflict resolution. Ensuring scalability and flexibility in the system design is also essential to accommodate the evolving needs and complexities of real-world applications. As such, a deep understanding of the underlying principles governing agent interactions and the ability to model these interactions accurately are critical for the successful deployment of the multi-agent system.

Accordingly, implementations herein are directed towards an interactive canvas that enables creating and updating multi-agent systems. The interactive canvas obtains a use case associated with a task. The use case may be associated with one or more artificial intelligence (AI) agents each associated with a respective one or more tools. The interactive canvas identifies a multi-agent system for performing the task and generates a graphical representation of the multi-agent system. The graphical representation includes relational indicators regarding the multi-agent system. The interactive canvas obtains an input interaction that is directed to the graphical representation of the multi-agent system. The interactive canvas updates the graphical representation based on the input interaction.

Advantageously, the interactive canvas provides a visual representation of the multi-agent system, making it easier for users to understand the structure, relationships, and interactions among the agents. The visualization aids in identifying potential issues, optimizing agent roles, and ensuring effective coordination. Moreover, by allowing users to input modified instructions and update the multi-agent system in real-time, the interactive canvas supports dynamic modification of the multi-agent system. This dynamic modification ensures that users may adapt the multi-agent system to changing requirements and tasks without the need for extensive reprogramming, thereby enhancing scalability and flexibility. The interactive canvas may also provide real-time feedback on predicted performance and behavior of the multi-agent system. As such, the feedback loop allows for rapid iteration and refinement of the multi-agent system, ensuring that the multi-agent system meets the desired objectives and performs optimally.

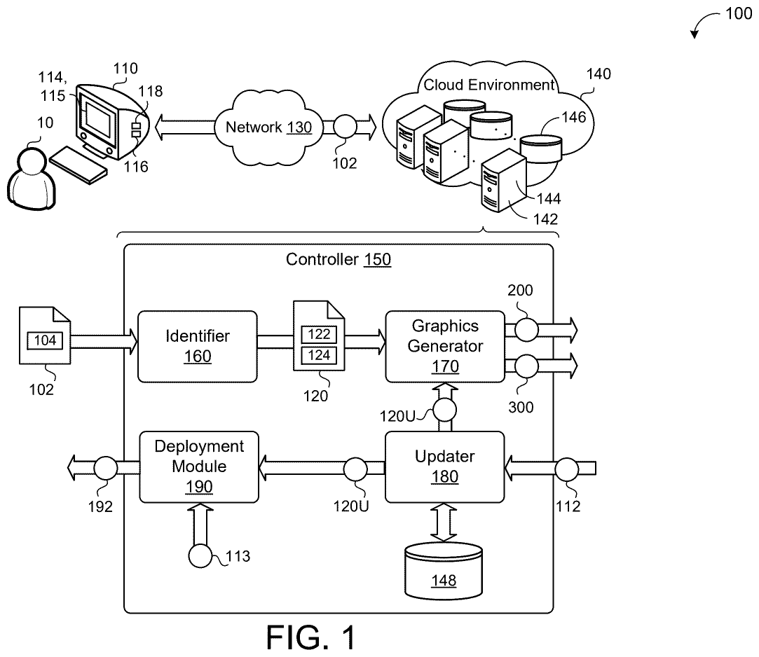

Referring to FIG. 1, in some implementations, a system 100 includes a remote system 140 in communication with one or more user devices 110 each associated with a respective user 10 via a network 130, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 110 via the network 130. The user device 110 may correspond to any computing device, such as a desktop workstation, a laptop workstation, or a mobile device (i.e., a smart phone). Each user device 110 includes computing resources 116 (e.g., data processing hardware) and/or storage resources 118 (e.g., memory hardware). The data processing hardware 116 executes a graphical user interface (GUI) 115 for display on a screen 114 in communication with the data processing hardware 116.

The remote system 140 and/or the user device 110 may execute a controller 150. The controller 150 is configured to generate a graphical representation 200 of a multi-agent system 120 and generate an updated graphical representation 300 based on an input interaction 112. The input interaction 112 reflects any changes or updates the user 10 made to the multi-agent system 120 via the graphical representation 200. The controller 150 communicates the graphical representation 200 and the updated graphical representation 300 to the user device 110 whereby the GUI 115 is configured to display the graphical representation 200 and the updated graphical representation 300 on the screen 114 of the user device 110. As such, the GUI 115 provides the user 10 with a visual and interactive interface to understand and manipulate the multi-agent system 120. The controller 150 includes an identifier 160, a graphics generator 170, an updater 180, a deployment module 190, and a database 148. The database 148 may be overlain on the storage resources 146 to allow scalable use of the storage resources 146.

In some implementations, the controller 150 obtains a use case 102 associated with a task 104. The task 104 may include one or more specific actions or steps to achieve or solve the use case 102. The use case 102 serves as a scenario or problem that the user 10 wants to address using the multi-agent system 120 by providing a framework for defining the objectives and requirements of the task 104. For example, the controller 150 may receive the use case 102 from the user device 110 via the network 130. The use case 102 may include a natural language description of a problem or goal that the user 10 wants to achieve or solve using the multi-agent system 120. Thus, the identifier 160 identifies the multi-agent system 120 for performing the task 104 associated with the use case 102. The multi-agent system 120 may include one or more artificial intelligence (AI) agents 122 whereby the AI agents 122 are configured to work together by cooperating or coordinating with each other to carry out the task 104. For instance, cooperation among the AI agents 122 may involve sharing information and resources to achieve a common goal, while coordination ensures that the actions of the AI agents 122 are harmonized to avoid conflicts and redundancies.

Moreover, each respective AI agent 122 may be associated with a respective one or more tools 124 that enable the respective AI agent 122 to perform its assigned role or function in the multi-agent system 120. Each tool 124 includes specialized software or hardware resources that provide the AI agent 122 with certain capabilities or skills. For example, one of the tools 124 may include a skill, such as speech recognition, natural language understanding, or sentiment analysis. Another one of the tools 124 may include a retrieval augmented generation (RAG) large language model (LLM), which is a neural network capable of generating natural language responses based on retrieved information from a knowledge base. Yet another one of the tools 124 may be a sub flow, which is a sequence of actions or steps that the AI agent 122 can execute as part of the task 104. Another tool 124 may include a coding script that allows the AI agent 122 to perform complex or customized operations, such as integrating with a third-party application or performing data analysis. In some examples, the tool 124 may include a flow action, which is a specific action that the AI agent 122 can perform, such as sending a message, making a call, or updating a record. In some configurations, one or more tools 124 may be shared among multiple AI agents 122. For example, two AI agents 122 may share a natural language processing tool 124 to interpret and generate human language. In this scenario, the shared tool 124 may appear twice in the graphical representation. One relational indicator 203 connects the first AI agent 122 and to the first instance of the shared tool 124, and another relational indicator 203 connects the second AI agent 122 to the second instance of the shared tool 124. Alternatively, the shared tool 124 may be shown once in the graphical representation 200. In this case, a first relational indicator 203 would connect the shared tool 124 to the first AI agent 122, and a second relational indicator 203 would connect the shared tool 124 to the second AI agent 122.

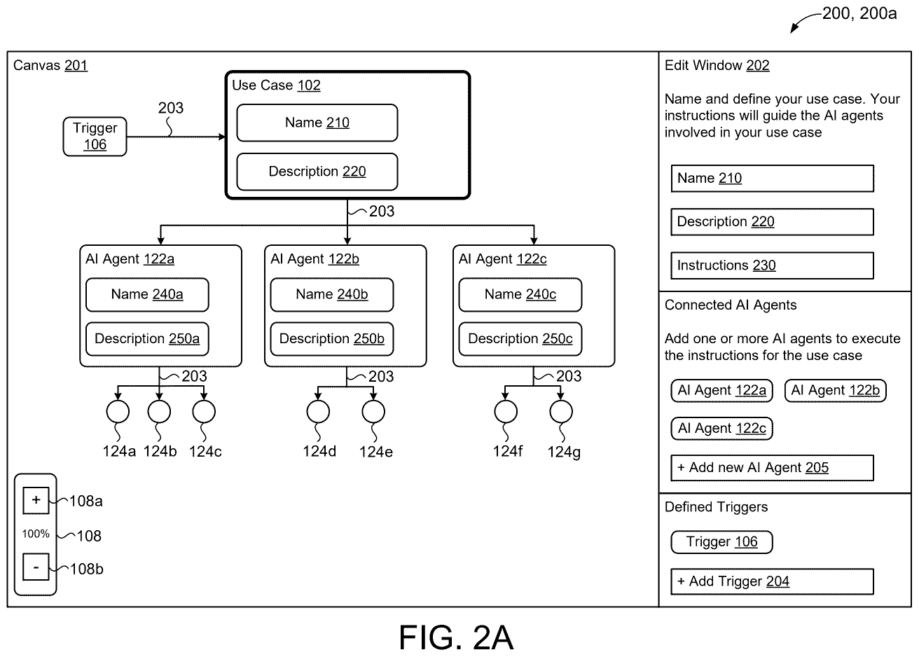

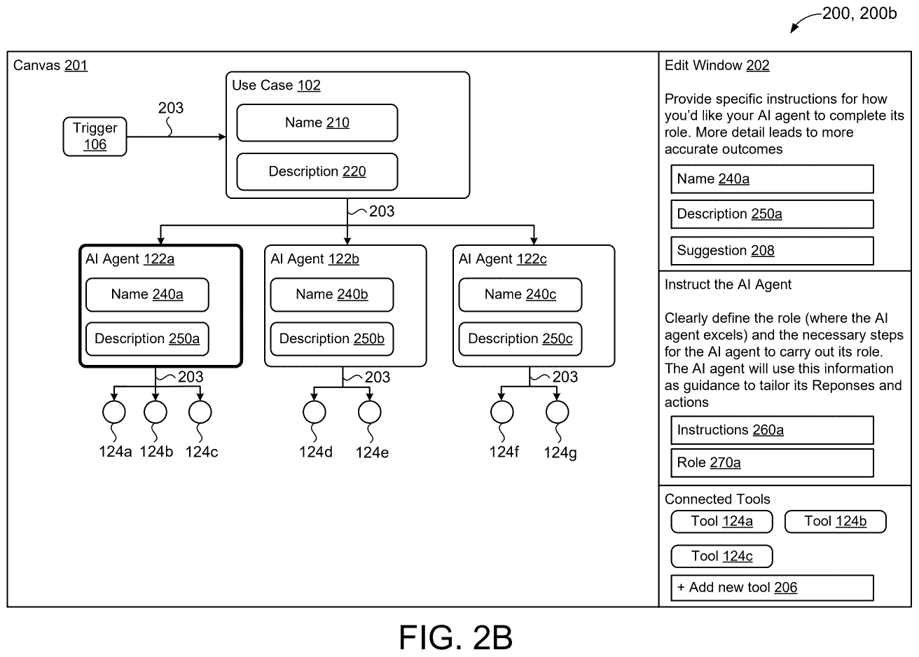

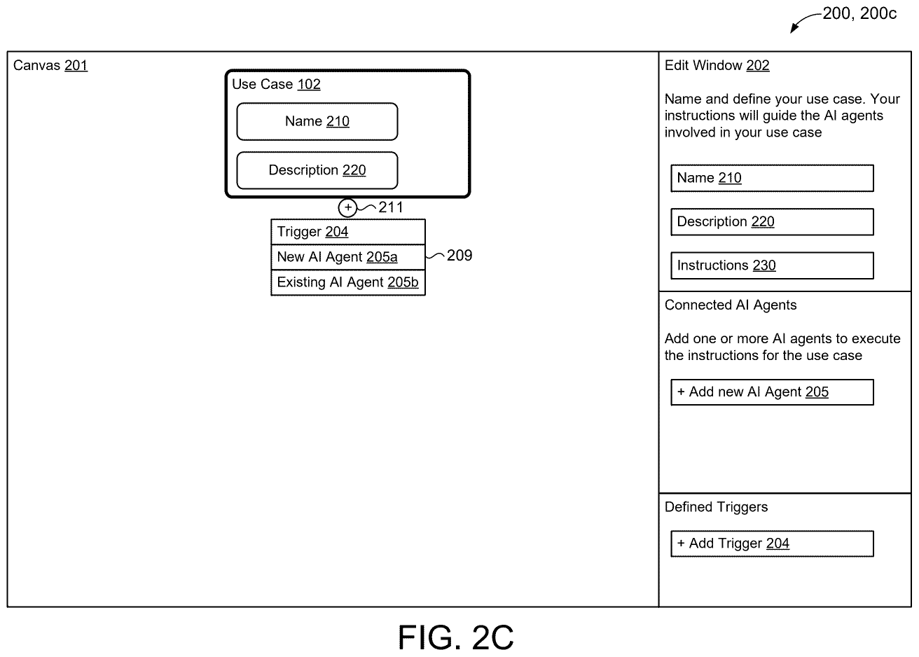

The graphics generator 170 generates a graphical representation 200 of the multi-agent system 120. The graphical representation 200 depicts the use case 102 and the multi-agent system 120 including the one or more AI agents 122 and tools 124. In some examples, the graphical representation 200 includes relational indicators 203 (FIG. 2) regarding the multi-agent system 120. Advantageously, the visual representation helps users 10 understand the structure and dynamics of the multi-agent system 120 by illustrating how different AI agents 122 and tools 124 interact to achieve the task 104 of the use case 102. The relational indicators 203 provide insights into the dependencies and relationships among various components, making it easier to identify potential bottlenecks, optimize workflows, and ensure smooth operation. That is, the relational indicators 203 may represent relationships among the use case 102 and the one or more AI agents 122. For example, the relational indicators 203 may show how the use case 102 interacts with different AI agents 122, detailing the specific roles each AI agent 122 plays within the use case 102. Additionally or alternatively, the relational indicators 203 represent relationships between each respective AI agent 122 and the respective one or more tools 124 associated with the respective AI agent 122. As such, the relational indicators 203 may illustrate how each AI agent 122 utilizes the tools 124 associated with the AI agent 122, including the specific functions of the tools 124 and how the tools 124 are integrated with the AI agent 122.

The controller 150 transmits the graphical representation 200 of the multi-agent system 120 to the user device 110 via the network 130. The graphical representation 200, when received by the user device 110, is configured to cause the GUI 115 of the user device 110 to display the graphical representation 200. Thus, the GUI 115 allows the user 10 to interact with the graphical representation 200, providing a visual and interactive means to understand and manage the multi-agent system 120. The graphical representation 200, when displayed on a screen of the user device 110, allows the user 10 to interact with the graphical representation 200 of the multi-agent system 120 through various input methods such as touch, keyboard, or mouse. As will become apparent, the user 10 may manipulate elements within the graphical representation 200, triggering the controller 150 to update the graphical representation 200 to create an updated graphical representation 300, which is then displayed by the GUI 115 of the user device 110, creating an interactive experience. The dynamic interaction allows users 10 to see the immediate effects of changes made to the multi-agent system 120.

FIGS. 2A-2C illustrate the graphical representation 200 as displayed by the GUI 115. The graphical representation 200 includes a canvas 201 and an edit window 202. The canvas 201 visually depicts the use case 102, the one or more AI agents 122, the relational indicators 203, and the tools 124. The use case 102 may be associated with a trigger 106. The user 10 may interact with the elements displayed on the canvas 201 by selecting any one of the elements (e.g., the use case 102, one of the AI agents 122, one of the tools 124, etc.) for editing. Editing may include adding, deleting, modifying, or rearranging any of the elements on the canvas 201. Once one of the elements in the canvas 201 is selected, the edit window 202 depicts information related to the selected element. For instance, in some examples, the use case 102 includes a name 210, a description 220, and instructions 230. As such, when the use case 102 is selected on the canvas 201, the edit window 202 displays the name 210, the description 220, and the instructions 230 of the use case 102.

The name 210 is a label that identifies the use case 102 and provides a concise summary of the task 104. For example, the name 210 may be “Okta verification +resolution.” The description 220 of the use case 102 provides a detailed explanation, in natural language, of the task 104 associated with the use case 102. The description 220 offers more comprehensive information compared to the name 210, which is typically more concise and less descriptive. For example, the description 220 may include “specializes in resolving the most common Okta issues.” The instructions 230 serve as guidelines that specify how the controller 150 should generate, assign, and monitor the AI agents 122 based on the use case 102. The guidelines ensure that the AI agents 122 are deployed effectively, with clear roles and responsibilities. The instructions 230 may generally characterize the task 104 associated with the use case 102 and may include parameters, rules, algorithms, or models that the controller 150 can use to optimize the performance of the multi-agent system 120. For example, the instructions 230 may include “this use case can handle task requests that require analysis, such as data validation, error detection, and automated troubleshooting.” In some implementations, the text box for the instructions 230 queries a large language model (LLM) such that the user 10 may leverage the LLM to create, modify, or improve instructions 230 for the use case 102 by inputting their initial ideas or incomplete instructions 230 into the text box. The LLM then processes the text input and provides suggestions, completions, or enhancements for the instructions. This interaction allows the user 10 to refine the instructions 230, making the instructions 230 clearer, more comprehensive, and better suited to the specific use case 102.

The canvas 201 shown in FIGS. 2A and 2B visually represents a use case 102 associated with the trigger 106. A relational indicator 203 depicts the relationship between the trigger 106 and the use case 102. The trigger 106 may be an event or condition that initiates the use case, such as a user login attempt or a system alert. Moreover, the use case 102 is associated with three AI agents 122a-c, each with relational indicators 203 depicting their relationship to the use case 102. The first AI agent 122a is associated with three respective tools 124a-c, the second AI agent 122b is associated with two respective tools 124d, 124e, and the third AI agent 122c is associated with two respective tools 124f, 124g. Each AI agent 122 has relational indicators showing the connection between the AI agent 122 and the corresponding tools 124. In some configurations, a name of the tool 124 and a description of each tool 124 are displayed on the canvas 201, providing more context about how the functions of the tools 124 and how the tools 124 assist the AI agents 122 in performing the task 104. However, the example shown in FIGS. 2A and 2B is exemplary only as it is understood that the use case 102 may be associated with any number of AI agents 122 and each AI agent 122 may be associated with any number of tools 124.

As shown in FIG. 2A, a first graphical representation 200, 200a illustrates the use case 102 as the selected component by way of the thicker line in the canvas 201 to help the user 10 visually identify that the use case 102 is selected for editing. The edit window 202 displays information associated with the use case 102, providing a user-friendly interface for managing and editing the use case 102. In particular, the edit window 202 may include a respective text box for each of the name 210, the description 220, and the instructions 230 of the use case 102. The text boxes allow the user 10 to easily view and edit the attributes of the use case 102. Each text box may display the name 210, description 220, or instructions 230 associated with the use case 102 and allow the user 10 to modify the text. Moreover, the edit window 202 may display the AI agents 122 connected to the use case 102. In some configurations, the edit window 202 includes an agent icon 205 that allows the user 10 to add an additional AI agent 122 to the use case 102, facilitating the expansion and enhancement of the use case 102.

In some examples, the edit window 202 displays a trigger 106 associated with the use case 102. The trigger 106 may be shared among one of more of the use cases 102. The trigger 106 may be a condition that, when satisfied, causes the use case 102 to execute. Triggers 106 may include specific events, time-based conditions, or other criteria that initiate the use case 102. The edit window 202 displays the trigger 106 associated with the use case 102 and a trigger icon 204 that allows the user 10 to add additional triggers 106 to the use case 102. The user 10 may customize the triggers 106 to suit various operational requirements, providing flexibility in how and when the use case 102 is executed.

Optionally, the canvas 201 may display a zoom modification element 108 that has a zoom-in button 108, 108a and a zoom-out button 108, 108b. The zoom modification element 108 allows the user 10 to adjust the view of the canvas 201 by zooming in or out. The zoom-in button 108a increases the zoom ratio, making the elements on the canvas 201 appear larger, while the zoom-out button 108b decreases the zoom ratio, making the elements appear smaller. The zoom modification element 108 may display the current zoom ratio of the canvas 201. For example, as shown in FIG. 2A, the zoom ratio is 100%. If the user 10 clicks the zoom-in button 108a, the zoom ratio may increase to 125%, enlarging the view. Conversely, clicking the zoom-out button 108b may reduce the zoom ratio to 75%, shrinking the view. As such, the zoom modification element 108 helps users 10 to focus on specific details or get an overview of the entire canvas 201.

In some implementations, each respective AI agent 122 includes a name 240, a description 250, instructions 260, and a role 270. The name 240 identifies the AI agent 122 and indicates the role or function of the AI agent 122 within the multi-agent system 120. The description 250 may provide a natural language explanation of the capabilities, skills, and associated tools 124 of the AI agent 122. The instructions 260 guide the AI agent in performing the assigned portion of the task 104. The role 270 helps the orchestration agent identify the correct AI agent 122 based on the nature, scope, or complexity of the task. Put another way, the role 270 specifies the primary function and responsibilities of the AI agent 122 within the multi-agent system 120, ensuring that each AI agent 122 is assigned tasks that align with the specialized skills and capabilities of the AI agent 122. For instance, as shown in FIGS. 2A and 2B, the first AI agent 122a has a first name 240a and a first description 250a, the second AI agent 122b has a second name 240b and a second description 250b, and the third AI agent 122c has a third name 240c and a third description 250c. The first name 240a may include “Okta verify specialist” while the first description 250a includes “manages push notifications, app configuration issues, and device registration.” The second name 240b may include “Login issue specialist” while the second description 250b includes “addresses forgotten passwords, account lockouts, and multi-factor authentication problems.” The third name 240c may include “user account access agent” while the third description 250c includes “managing existing users, getting user details, accessing control based on user needs or roles.”

The names 240 and descriptions 250 help differentiate the AI agents 122 and clarify the specific roles of the AI agents 122 within the multi-agent system 120. The name 240 may identify the AI agent 122 and indicate the role or function of the AI agent 122 in the multi-agent system 120. The instructions 260 may include parameters, rules, algorithms, or models that the AI agent 122 can use to optimize its performance. For example, the instructions 260 for “DataCollector” may include specific parameters for data retrieval, rules for data validation, algorithms for data analysis, and models for generating reports. Moreover, the instructions 260 may detail inputs, outputs, or triggers for the tools 124, conditions or logic for the sub flow or the flow action, or variables or functions for the coding script.

As shown in FIG. 2B, a second graphical representation 200, 200b illustrates the first AI agent 122a as the selected component by way of the thicker line in the canvas 201 to help the user 10 visually identify that the first AI agent 122a is selected for editing. Here, the edit window 202 displays information associated with the first AI agent 122a, providing a user-friendly interface for managing and editing the first AI agent 122a. The edit window 202 is designed to be intuitive, allowing users 10 to easily navigate through various settings and options related to the AI agent 122. In particular, the edit window 202 may include a respective text box for each of the name 240a, the description 250a, and the instructions 260a of the first AI agent 122a. These text boxes are designed to be highly interactive, allowing the user 10 to input and update information with ease. The text boxes allow the user 10 to easily view and edit the attributes of the first AI agent 122a. Each text box may display the name 240a, description 250a, or instructions 260a associated with the first AI agent 122a and allow the user 10 to modify the text. This functionality is particularly useful for fine-tuning the behavior of the AI agent 122 ensuring that the AI agent 122 operates in a manner desired by the user 10.

Moreover, the edit window 202 may display the tools 124 connected to the first AI agent 122a. As such, the user 10 may visualize all tools 124 currently available to the AI agent 122 within the edit window 202. In some configurations, the edit window 202 includes a tool icon 206, which is a clickable button or symbol that allows the user 10 to add an additional tool 124 to the first AI agent 122a. Thus, the tool icon 206 facilitates the expansion and enhancement of the AI agent 122 by making it easy to integrate new functionalities. The tool icon 206 is designed to be user-friendly, meaning it is easy to understand and use, even for users 10 without extensive technical knowledge. When the user 10 clicks on the tool icon 206, a library or list of available tools 124 is displayed. The user 10 may browse through the library, select the desired tool, and instantly add the selected tool 124 to the AI agent 122. Thus, the tool icon 206 is particularly useful for adapting the AI agent 122 to new tasks or improving the performance of the AI agent 122 by equipping the AI agent 122 with additional tools 124.

For instance, if the AI agent 122 is initially designed for text processing but later needs to perform image recognition, the user 10 may add an image recognition tool 124 to the AI agent 122 through the tool icon 206. In some instances, the edit window 202 may include a suggestion 208. The suggestion 208 may indicate that the selected AI agent 122 is missing a tool 124 required to perform the instructions 260 or does not have any associated tools 124 at all. For instance, the suggestion 208 may state, “missing tool. This AI agent needs a tool in order to take action.” Thus, the suggestion ensures that the user 10 is aware of any missing components that are necessary for the AI agent 122 to function correctly.

Referring now to FIG. 2C, in some implementations, a third graphical representation 200, 200c includes the use case 102 and a pop-up window 209. The use case 102 includes the name 210 and the description 220. Here, instead of adding triggers or AI agents 122 to the use case 102 through the edit window 202, the user 10 may select the pop-up window 209. For instance, the pop-up window 209 may appear when the user 10 hovers the mouse over an icon 211 (e.g., “+” icon) associated with the use case 102 displayed in the canvas 201. Alternatively, the pop-up window may appear when the user 10 uses the mouse to click icon 211. The hover action triggers the pop-up window 209, making it easy for the user 10 to access additional options without navigating away from the canvas 201. The pop-up window 209 may include the trigger icon 204 (similar to the trigger icon 204 in the edit window 202) that enables the user 10 to add a trigger 106 to the use case 102. Moreover, the pop-up window 209 may include the agent icon 205 that allows the user 10 to add additional AI agents 122 to the use case 102. Here, the pop-up window 209 may include a new AI agent icon 205, 205a and an existing AI agent icon 205, 205b. The new AI agent icon 205a enables the user 10 to add a new AI agent 122 that does not exist in the database 148 to the use case 102. On the other hand, the existing AI agent icon 205b allows the user 10 to add an existing AI agent that does exist in the database 148 to the use case 102.

Referring back to FIG. 1, after transmitting the graphical representation 200 to the user device 110, the controller 150 may obtain an input interaction 112 that is directed to the graphical representation 200 of the multi-agent system 120. The input interaction 112 may be in the form of a touch, click, or other user action that the controller 150 recognizes and processes to perform specific functions or commands within the multi-agent system 120. For example, a user 10 might click on an icon representing an AI agent 122 to view its details or drag a tool 124 to a different location to change the association of the tool 124 to another AI agent 122. The input interaction 112 may be any modification of the graphical representation 200 of the multi-agent system 120. The modification may involve altering visual elements of the graphical representation 200, such as icons, labels, or relational indicators 203 that represent the relationships and interactions between different AI agents 122 and tools 124. For instance, a user 10 may change the label of an AI agent 122 to better describe its function or adjust a relational indicator 203 to reflect a new interaction between AI agents 122.

More specifically, the input interaction 112 may be directed to the canvas 201 or the edit window 202 of the graphical representation 200 displayed on the GUI 115. As such, the canvas 201 may serve as the main workspace where users 10 visually manipulate the components of the multi-agent system 120. For instance, the input interaction 112 may click, drag, or rearrange the components displayed on the canvas 201. Clicking the components on the canvas 201 may allow the user 10 to add or delete components, such as adding a new AI agent 122 or removing an existing tool 124. On the other hand, the edit window 202 provides a more detailed interface for modifying the properties and settings of individual components. The input interaction 112 may include clicking or typing within the edit window 202 to change parameters of the AI agent 122 or to update the configuration of a tool 124.

For instance, the modification may involve changing the name 210, the description 220, or the instructions 230 of the use case 102. Changing the name 210 may help in better identifying the use case 102, making it more intuitive for users to recognize and differentiate between various use cases 102. Updating the description 220 provides more accurate or detailed information about the purpose and scope of the use case 102, ensuring all stakeholders have a clear understanding of the objectives and requirements. Modifying the instructions 230 alters the operations or the criteria for executing specific tasks within the use case 102, thereby enhancing the functionality of the use case 102. Moreover, the modification may modify the name 240, the description 250, or the instructions 260 of any of the AI agents 122 connected to the use case 102.

Adjusting the name 240 of an AI agent 122 may make it easier to identify the role of the AI agent 122 within the use case 102. Updating the description 250 provides more context about the capabilities and functions of the AI agent 122. Modifying the instructions 260 changes how the AI agent 122 interacts with other AI agents 122 or tools 124, which may optimize the performance of the AI agent 122 or enable the AI agent 122 to handle new types of tasks. In some examples, the modification may add, delete, or rearrange one of the AI agents 122 or the tools 124. Adding a new AI agent 122 introduces additional capabilities or enhances the functionality of the use case 102. Deleting an AI agent 122 simplifies the use case 102 or removes redundant or obsolete functions. Rearranging the AI agents 122 or tools 124 may optimize the use case 102, improve efficiency, or adapt the use case 102 to new operational requirements.

Accordingly, the updater 180 receives the input interaction 112 and updates the multi-agent system 120 based on the input interaction 112. The graphics generator 170 receives the updated multi-agent system 120U, which reflects the changes to the multi-agent system 120U made by the updater 180 and updates the graphical representation 200 accordingly. That is, the graphics generator 170 generates an updated graphical representation 300 to reflect the updated multi-agent system 120U. The updated graphical representation 300 may include new visual elements or alter existing visual elements to accurately depict the updated multi-agent system 120U. For example, if a new AI agent 122 is added, the updated graphical representation 300 will show this new AI agent 122 along with its connections to other components. The controller 150 transmits the updated graphical representation 300 to the user device 110 via the network 130. The updated graphical representation 300, when received by the user device 110, is configured to cause the GUI 115 of the user device 110 to display the updated graphical representation 300. The updated graphical representation 300, when displayed on a screen of the user device 110, allows the user 10 to interact with the updated graphical representation 300 to further modify the multi-agent system 120.

The updater 180 sends the updated multi-agent system 120U to the deployment module 190 which deploys the updated multi-agent system 120U. Once deployed, the updated multi-agent system 120U may receive a prompt 113. The prompt 113 may be a natural language input specifying a specific action for the updated multi-agent system 120U to perform. For example, a user 10 may input a prompt 113 such as “analyze the latest sales data” or “generate a report on customer feedback.” The updated multi-agent system 120U performs the specific action based on the prompt 113 utilizing the AI agents 122 and tools 124 to achieve the desired outcome. Advantageously, the user 10 may create and modify the use case 102 and the multi-agent system 120 via the GUI 115 and then deploy the multi-agent system 120 to perform actions. In some instances, the multi-agent system 120 generates notifications 192 based on the actions the multi-agent system 120 performed and provides the notifications 192 to the user device 110.

In some implementations, the input interaction 112 modifies the task 104 of the use case 102, resulting in a modified task 104 that the multi-agent system 120 needs to perform. For instance, the input interaction 112 may change the instructions 230 of the use case 102 via the edit window 202, thereby altering the task 104 associated with the use case 102. Alternatively, the input interaction 112 may modify the instructions 260 of one of the AI agents 122. In some examples, the input interaction 112 may rearrange one or more of the relational indicators 203. In yet other examples, the input interaction 112 may add, delete, or modify one of the AI agents 122, thereby changing the composition of the multi-agent system 120.

The modified task 104 may be significant enough to require one or more additional AI agents 122 and/or one or more additional tools 124 to handle the new requirements of the modified task 104. For example, if the modified task 104 involves more complex data analysis, an additional AI agent 122 with specialized data processing tools 124 may be needed. In this example, the additional AI agent 122 may include tools 124 for advanced statistical analysis, enabling the additional AI agent 122 to handle large datasets and perform intricate calculations. Similarly, if the modified task 104 requires enhanced natural language processing, an AI agent 122 equipped with advanced language models or sentiment analysis tools 124 may be necessary. Based on the input interaction 112, the updater 180 updates the multi-agent system 120 by generating an updated multi-agent system 120U that includes the additional AI agent 122 and/or additional tools 124. Thereafter, the graphics generator 170 generates the updated graphical representation 300 to reflect the updated multi-agent system 120U, which includes the additional AI agent 122 or the additional tool 124. The updated graphical representation 300 helps the user 10 visualize the changes and understand how the new AI agents 122 and tools 124 will work together to achieve the modified task 104. For instance, the updated graphical representation 300 may show how the new AI agent 122 integrates with existing AI agents 122 and tools 124.

In some examples, the updater 180 is in communication with the database 148 of AI agents 122. The updater 180 determines that the additional AI agent 122 to perform the modified task 104 exists in the database 148 for AI agents 122 that match the requirements of the modified task 104. For instance, if the modified task 104 involves an IT management task, the updater 180 searches for AI agents 122 with capabilities in IT management. The search involves comparing the requirements of the modified task 104 with the capabilities listed in the database 148 by way of the descriptions 250 of the AI agents 122. As such, the updater 180 updates the multi-agent system 120 by adding the additional AI agent 122 to the multi-agent system 120. For example, if the multi-agent system 120 initially includes AI agents 122 specialized in image recognition and the modified task 104 requires IT management, the updater 180 integrates an AI agent 122 with IT management capabilities into the updated multi-agent system 120. In some instances, the input interaction 112 does not alter the multi-agent system 120 but rather alters the canvas 201. For instance, the input interaction 112 may select the zoom-in button 108a or the zoom-out button 108b (e.g., a zoom modification). Here, the graphics generator 170 may receive the input interaction 112 directly in addition to, or in lieu of, the updater 180. The updater 180 may update the multi-agent system 120 using methods described by U.S. patent application Ser. No. 18/936,269, filed on Nov. 4, 2024. The disclosure of this prior application is considered part of the disclosure of this application and is hereby incorporated by reference in its entirety.

In some implementations, the updater 180 determines that the additional AI agent 122 that performs the modified task 104 exists in the database 148 by determining a similarity threshold is satisfied between the modified task 104 and a description 250 of the additional AI agent 122. For instance, the updater 180 may compare keywords or functional capabilities listed in the description 250 of the AI agent 122 with those required by the modified task 104. In other examples, the updater 180 determines that the additional AI agent 122 to perform the modified task 104 does not exist in the database 148. Here, the updater 180 fails to find any AI agents 122 in the database 148 that meet the similarity threshold for the modified task 104. As such, the updater 180 generates the additional AI agent 122 (e.g., a new AI agent 122) to perform the modified task 104 and updates the multi-agent system 120 by adding the additional AI agent 122 to the multi-agent system 120. For example, if the modified task 104 requires a new type of IT management that no existing AI agents 122 perform, the updater 180 creates a new AI agent 122 with the necessary IT management capabilities and adds the new AI agent 122 into the multi-agent system 120.

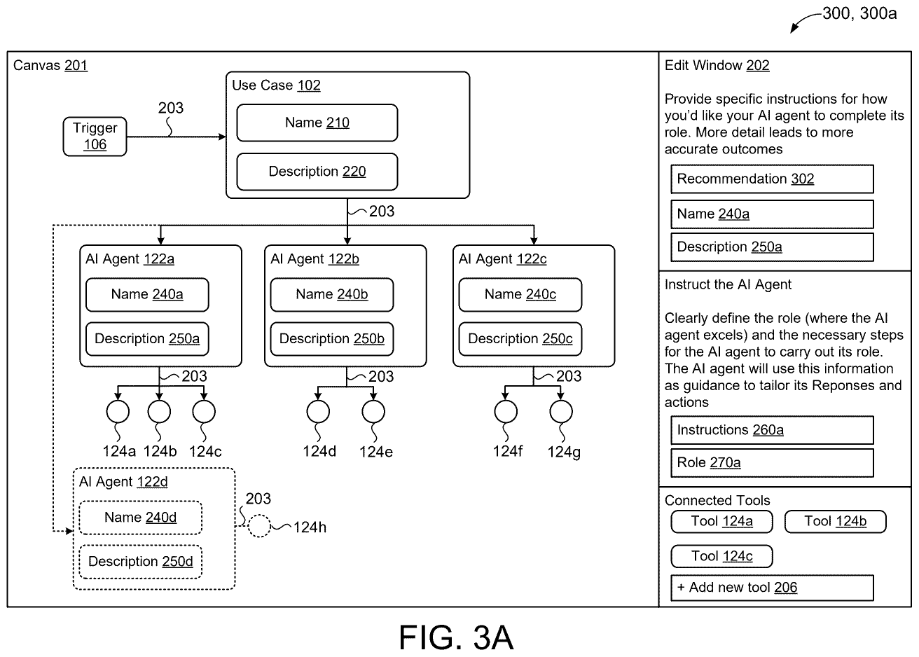

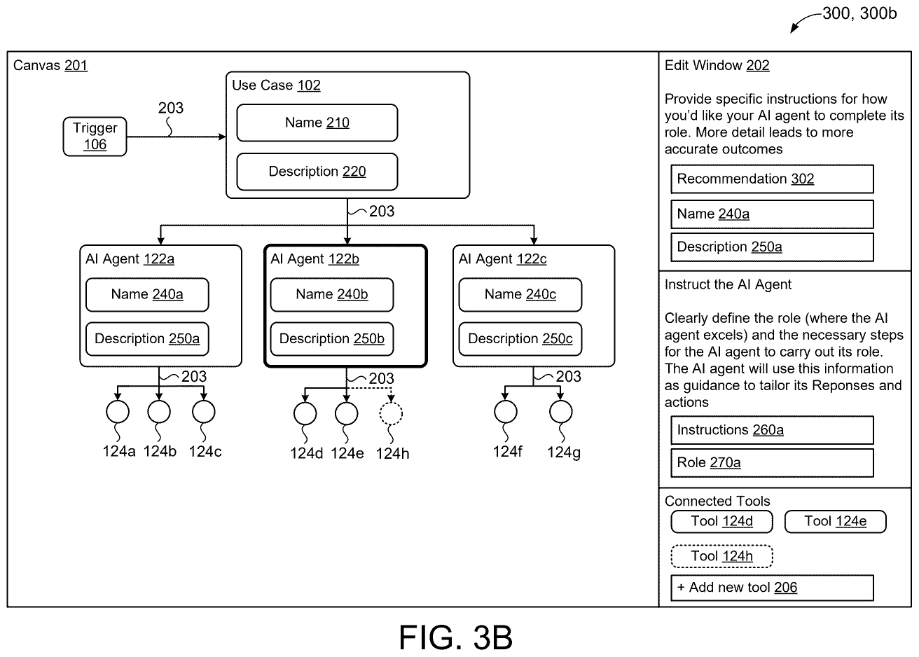

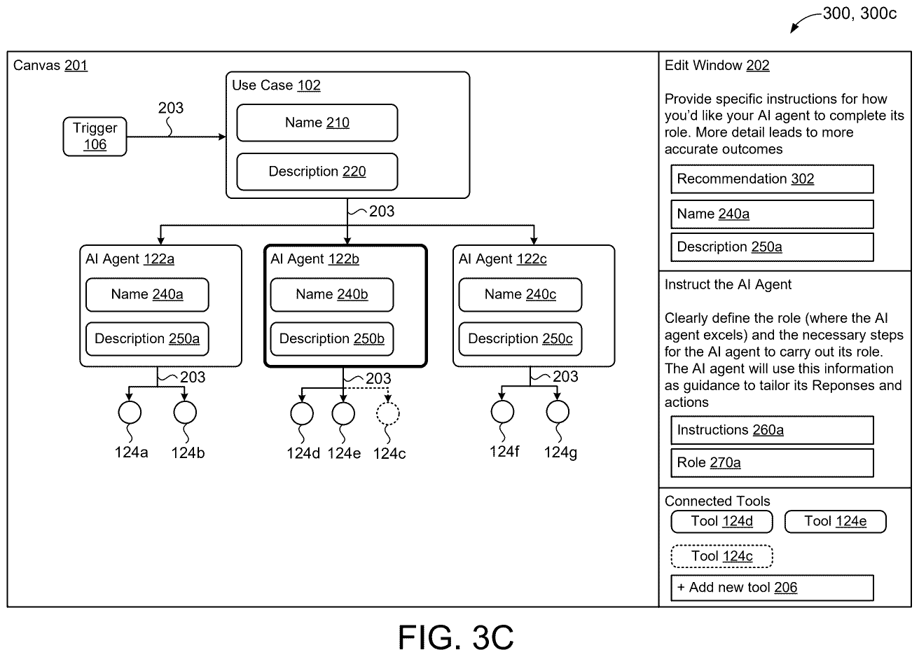

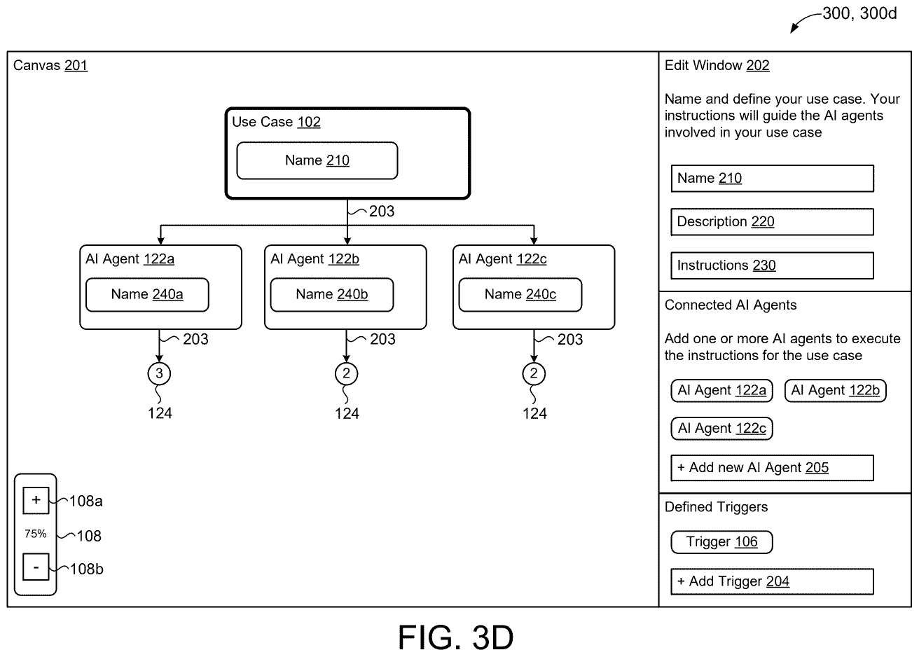

FIGS. 3A-3D illustrates example updated graphical representations 300. In particular, the updated graphical representations 300 represent updates to the graphical representation 200 (FIGS. 2A-2C) based on the input interaction 112. The updated graphical representation 300 includes the canvas 201 and the edit window 202. The canvas 201 visually depicts the use case 102, the one or more AI agents 122, the relational indicators 203, and the tools 124. The user 10 may interact with the elements displayed on the canvas 201 by selecting any one of the elements (e.g., the use case 102, one of the AI agents 122, one of the tools 124, etc.) for editing. Editing may include adding, deleting, modifying, or rearranging any of the elements on the canvas 201. Once one of the elements in the canvas 201 is selected, the edit window 202 depicts information related to the selected element.

The canvas 201 shown in FIGS. 3A-3D visually represents a use case 102 associated with a trigger 106. The relational indicator 203 depicts the relationship between the trigger 106 and the use case 102. Moreover, the use case 102 is associated with three AI agents 122a-c, each represented with relational indicators 203 that depict relationship to the use case 102. The first AI agent 122a is associated with three respective tools 124a-c, the second AI agent 122b is associated with two respective tools 124d, 124e, and the third AI agent 122c is associated with two respective tools 124f, 124g. Each AI agent 122 has relational indicators showing the connection between the AI agent 122 and the corresponding tools 124. In some configurations, a name of the tool 124 and a description of each tool 124 are displayed on the canvas 201, providing more context about how the functions of the tools 124 and how the tools 124 assist the AI agents 122 in performing the task 104.

FIG. 3A illustrates a first updated graphical representation 300, 300a generated based on an input interaction 112 that modifies the task 104 of the use case 102 shown in FIG. 2A. In particular, the input interaction 112 may replace or modify the instructions 230 of the use case 102 such that the AI agents 122a-c associated with the use case 102 are not capable of performing the modified task 104. Put another way, this modification may render the existing AI agents 122a-c associated with the use case 102 incapable of performing the modified task 104. For instance, if the original task 104 involved data analysis and the modification requires natural language processing, the existing AI agents 122a-c may lack the necessary capabilities to handle the new requirements. As such, the updater 180 identifies the need for an additional AI agent 122 (e.g., fourth AI agent 122d) that, together with the existing AI agents 122a-c performs the modified task 104.

Thus, the first updated graphical representation 300a depicts the fourth AI agent 122d in the canvas 201. The fourth AI agent 122d includes a fourth name 240, 240d and a fourth description 250d. The fourth name 240d may include “user provisioner” whereby the fourth description 250d includes “focuses on user creation, user deletion, and synchronization issues.” The fourth AI agent 122 is associated with a corresponding tool 124h. Moreover, the first updated graphical representation 300a includes a recommendation 302 that includes a natural language explanation of why the fourth AI agent 122d is being recommended. For instance, the recommendation 302 may state, “the fourth AI agent is recommended because it possesses capabilities for user management and synchronizes issues,” explaining the rationale behind the inclusion of the fourth agent 122d. Notably, the first updated graphical representation 300a depicts relational indicators 203 between the use case 102 and the fourth AI agent 122d and between the fourth AI agent and the tool 124h as dotted lines to highlight the modification made to the multi-agent system 120.

FIG. 3B illustrates a second updated graphical representation 300, 300b generated based on an input interaction 112 that modifies the task 104 of the use case 102 shown in FIG. 2A. In particular, the input interaction 112 may replace or modify the instructions 230 of the use case 102, making the AI agents 122a-c associated with the use case 102 unable to perform the modified task 104. For example, if the original task 104 involved simple data entry and the modification requires complex data visualization, one or more of the existing AI agents 122a-c may not have the necessary tools 124. Alternatively, the input interaction 112 may replace or modify the instructions 260 of one of the AI agents 122 (e.g., the second AI agent 122b). Therefore, the updater 180 identifies an additional tool 124h for the second AI agent 122b based on the input interaction 112. The additional tool 124h enables the AI agents 122 to perform the modified task 104 of the use case 102 or the updated instructions 260 of the AI agent 122. Thus, the second updated graphical representation 300b depicts the second AI agent 122b with the additional tool 124h in the canvas 201. Additionally, the second updated graphical representation 300b includes the recommendation 302 that includes a natural language explanation of why the second AI agent 122b needs the additional tool 124h to perform the modified task. For instance, the recommendation 302 may state, “the second AI agent requires the additional tool to handle complex data visualization, which is essential for the modified task.”

FIG. 3C illustrates a third updated graphical representation 300, 300c generated based on an input interaction 112 directed to the graphical representation 200 as shown in FIG. 2A. Here, the input interaction 112 may rearrange one of the relational indicators 203. More specifically, the input interaction 112 may include rearranging the relational indicator between the first AI agent 122a and the tool 124c to now be between the second AI agent 122b and the tool 124c. As such, the tool 124c is now associated with the second AI agent 122b rather than the first AI agent 122a. Therefore, the updater 180 rearranges the multi-agent system 120 such that the tool 124c is no longer associated with the first AI agent 122a and is now associated with the second AI agent 122b. The rearrangement ensures that the second AI agent 122b has necessary resources to perform its tasks. Additionally, the third updated graphical representation 300c includes the recommendation 302 that includes a natural language explanation of why the relational indicator needs to be between the second AI agent 122b and the tool 124c. For example, the recommendation 302 may state, “The tool is better suited for the tasks assigned to the second AI agent, which now requires this tool to function effectively.” This explanation helps users understand the rationale behind the reassignment of resources. The relational indicator between the second AI agent 122b and the tool 124c may be denoted by a dotted line to highlight the change.

FIG. 3D illustrates a fourth updated graphical representation 300, 300d generated based on an input interaction 112 directed to the graphical representation 200 as shown in FIG. 2A. In this example, the input interaction 112 involves selecting the zoom-out button 108b displayed on the canvas 201 of the graphical representation 200 shown in FIG. 2A. As a result, the input interaction 112 changes the zoom ratio of the canvas to change from 100% to 75%. Here, the graphics generator 170 may receive the input interaction 112 and generate the updated graphical representation 300 based on the input interaction 112. Notably, the updated graphical representation 300 abstracts away (i.e., conceals) certain details from the use case 102 and the multi-agent system 120 to provide a more simplified view.

Specifically, the canvas 201 no longer displays the trigger 106 and the use case 102 only shows the name 210, unlike in FIG. 2A where more details were visible. Moreover, each AI agent 122 now only displays the corresponding name 240, omitting the description 250. The updated graphical representation 300 also simplifies the display of tools 124 associated with each AI agent 122. Instead of showing all tools 124, only one tool per AI agent 122 is shown with an indicator of the total number of tools 124 associated with that AI agent 122. For example, the tool 124 associated with the first AI agent 122a displays the number “3” indicating that the first AI agent 122a is associated with 3 tools 124, even though only a single tool 124 is visually represented. Advantageously, the GUI 115 benefits from zooming in and out by allowing users 10 to focus on specific details when needed (zooming in) or to get a broader overview of the entire graphical representation (zooming out). This flexibility enhances user 10 interaction and efficiency by providing both detailed and high-level views as required.

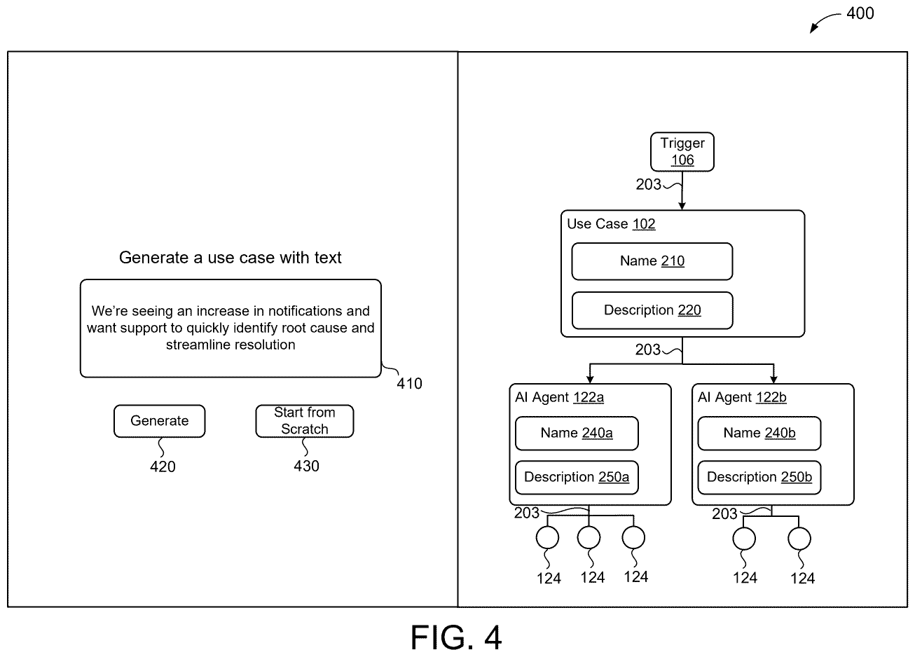

FIG. 4 illustrates a user interface view 400 displayed on the GUI 115 of the user device 110. The user interface view 400 includes a text box 410 that allows users 10 to provide natural language inputs to generate a use case 102 and a multi-agent system 120. Some users 10 may have limited knowledge of building use cases 102 and multi-agent systems 120. The text box 410 provides a way for users 10 to explain, in natural language, the use case 102 and multi-agent system 120 the user 10 wants to develop. For example, a user 10 may type “I want to create a system that automates customer service responses.” The user interface view 400 also includes a generate button 420 and a start from scratch 430 button. By clicking the generate button 420, the text input in the text box 410 is sent to an LLM for processing. Alternatively, by clicking the start from scratch button 430, the view changes to the graphical representation 200 as shown in FIGS. 2A-2D. The graphical representation 200 allows the user 10 to customize or modify the multi-agent system 120. The LLM processes the natural language input provided to the text box 410 and generates a recommended use case 102 and multi-agent system 120. Based on the natural language input, the LLM determines the intent of the user 10 and recommends a use case 102 which is associated with a trigger 106 and one or more AI agents 122. The use case includes a name 210 and a description, and each AI agent 122 includes a corresponding name 240 and description 250. In the example shown, the recommendation includes a use case 102 associated with a trigger and two AI agents 122 each associated with tools 124. Moreover, the recommendation includes relational indicators 203.

The recommendation may serve as a starting point for the user 10 to create the use case 102 and the multi-agent system 120. In some instances, the user 10 may develop the recommendation by refining the use case 102, adding more detailed descriptions, and incorporating additional AI agents 122 and tools 124. This iterative process allows the user 10 to tailor the system to their specific needs and objectives, ensuring a more comprehensive and customized solution. After accepting the recommendation, the GUI 115 may display the graphical representation 200, allowing the user 10 to modify any of the components as needed. In some instances, the user 10 may develop the recommendation by refining the use case 102, adding more detailed descriptions, and incorporating additional AI agents 122 and tools 124. For example, the user 10 may change the names 240 and descriptions 250 of the recommended AI agents 122 or adjust the tools 124. This iterative process allows the user 10 to tailor the system to their specific needs and objectives, ensuring a more comprehensive and customized solution.

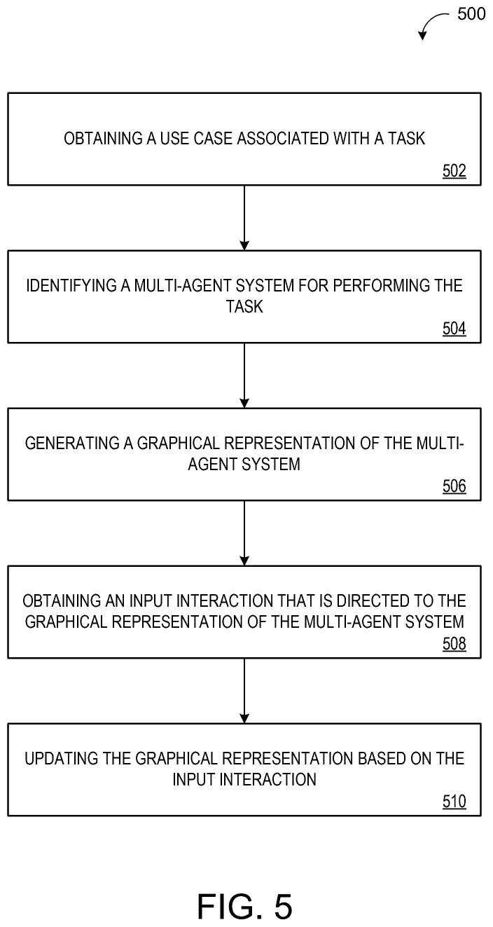

FIG. 5 is a flowchart of an exemplary arrangement of operations for a computer-implemented method 500 of updating a multi-agent system 120. At operation 502, the method 500 includes obtaining a use case 102 associated with a task 104. At operation 504, the method 500 includes identifying a multi-agent system 120 for performing the task 104. At operation 506, the method 500 includes generating a graphical representation 200 of the multi-agent system 120. The graphical representation 200 includes relational indicators 203 regarding the multi-agent system 120. At operation 508, the method 500 includes obtaining an input interaction 112 that is directed to the graphical representation 200 of the multi-agent system 120. The input interaction 112 enables users 10 to interact with the multi-agent system 120 to update the multi-agent system 120 accordingly. At operation 510, the method 500 includes updating the graphical representation 200 based on the input interaction 112. As such, the updated graphical representation 300 reflects the changes made to the multi-agent system 120 through the graphical representation 200.

The graphical representation 200 of the multi-agent system 120 allows users 10 to visualize and modify the relationships and interactions among various AI agents 122 and tools 124. Having a single user interface (e.g., the graphical representation 200), as compared with multiple graphical representations, results in fewer user inputs. For example, having multiple graphical representations may result in additional user inputs associated with navigating between the graphical representations. Accordingly, the graphical representation 200 enables less processor and memory utilization, based on processing fewer user inputs. The controller 150 allows users 10 to provide input interactions 112 and update the multi-agent system 120 in real-time accordingly. As such, the controller 150 enables users 10 to understand and manage the complex interactions and relationships among the AI agents 122 within the multi-agent system 120. The graphical representation 200 of the multi-agent system 120 helps users 10 to identify potential issues, optimize AI agent 122 roles, and ensure effective coordination. Moreover, by allowing users 10 to dynamically modify the multi-agent system 120, the controller 150 supports the adaptation of the multi-agent system 120 to changing requirements and tasks 104 without the need for extensive reprogramming. Avoiding the need for extensive reprogramming results in a corresponding reduction in processor and memory utilization.

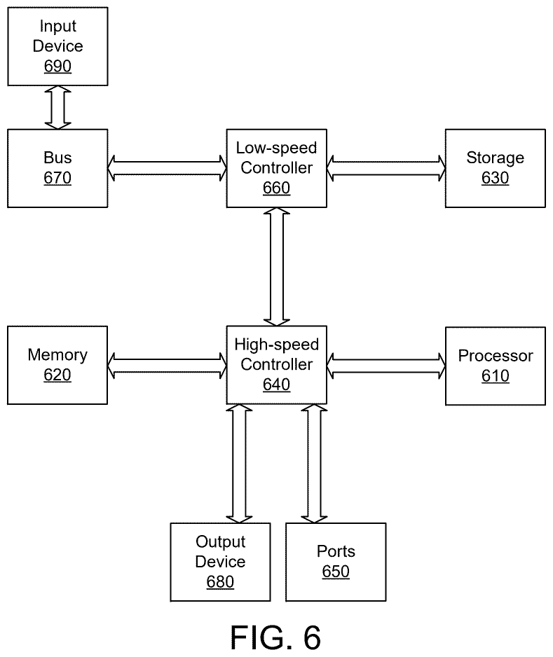

FIG. 6 is a schematic view of an example computing device 600 that may be used to implement the systems and methods described in this document. The computing device 600 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 600 includes a processor 610, memory 620, a storage device 630, a high-speed interface/controller 640 connecting to the memory 620 and high-speed expansion ports 650, and a low-speed interface/controller 660 connecting to a low-speed bus 670 and a storage device 630. Each of the components 610, 620, 630, 640, 650, and 660, are interconnected using various busses, and may be mounted on a common motherboard or in other manners as appropriate. The processor 610 can execute instructions for performing operations within the computing device 600, including instructions stored in the memory 620 or on the storage device 630 to display graphical information for a graphical user interface (GUI) on an external input/output device, such as display 680 coupled to high-speed interface 640. In other implementations, multiple processors and/or multiple buses may be used, as appropriate, along with multiple memories and types of memory. Also, multiple computing devices 600 may be connected, with each device providing portions of the necessary operations (e.g., as a server cluster, a group of blade servers, or a multi-processor system).

The memory 620 stores information within the computing device 600. The memory 620 may be a non-transitory computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 630 is capable of providing mass storage for the computing device 600. In some implementations, the storage device 630 is a non-transitory computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 620, the storage device 630, or memory on processor 610.

The high-speed controller 640 manages bandwidth-intensive operations for the computing device 600, while the low-speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port or input device 690. The low-speed expansion port 690, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining a use case including a task;
identifying a multi-agent system for performing the task;
generating a graphical representation of the multi-agent system, wherein the graphical representation includes relational indicators regarding the multi-agent system;
obtaining an input interaction that is directed to the graphical representation of the multi-agent system; and
updating the graphical representation based on the input interaction.

2. The method of claim 1, wherein the use case is associated with one or more artificial intelligence (AI) agents, each respective AI agent associated with a respective one or more tools.

3. The method of claim 2, wherein each respective AI agent comprises:
a name of the respective AI agent;
a description of the respective AI agent; and
instructions guiding the respective AI agent to perform a respective portion of the task.

4. The method of claim 2, wherein the relational indicators represent relationships among the use case and the one or more AI agents.

5. The method of claim 2, wherein the relational indicators represent, for each respective AI agent, relationships between the respective AI agent and the respective one or more tools associated with the respective AI agent.

6. The method of claim 1, wherein the input interaction comprises a modified task associated with the use case for the multi-agent system to perform.

7. The method of claim 6, further comprising updating the multi-agent system to include an additional AI agent to perform the modified task based on the input interaction.

8. The method of claim 7, further comprising:
deploying the updated multi-agent system;
obtaining a prompt; and
performing, using the updated multi-agent system, an action based on the prompt.

9. The method of claim 7, wherein updating the multi-agent system to include the additional AI agent to perform the modified task comprises:
determining that the additional AI agent to perform the modified task exists in a database of AI agents; and
based on determining that the additional AI agent to perform the modified task exists in the database of AI agents, adding the additional AI agent to the multi-agent system.

10. The method of claim 9, wherein determining that the additional AI agent to perform the modified task exists in the database of AI agents comprises determining a similarity threshold is satisfied between the modified task and a description of the additional AI agent.

11. The method of claim 7, wherein updating the multi-agent system to include the additional AI agent to perform the modified task comprises:
determining that the additional AI agent to perform the modified task does not exist in a database of AI agents;
based on determining that the additional AI agent to perform the modified task does not exist in the database of AI agents, generating the additional AI agent to perform the modified task; and
adding the additional AI agent to the multi-agent system.

12. The method of claim 1, further comprising receiving a natural language prompt describing the task.

13. The method of claim 12, wherein obtaining the use case comprises obtaining the use case based on the natural language prompt.

14. The method of claim 1, wherein the use case comprises a name of the use case and a description of the use case.

15. The method of claim 1, further comprising transmitting, to a user device, the updated graphical representation.

16. The method of claim 15, wherein the updated graphical representation, when received by the user device, is configured to cause a graphical user interface (GUI) of the user device to display the updated graphical representation.

17. The method of claim 1, wherein the input interaction comprises at least one of:
a rearrangement of the multi-agent system; or
a zoom modification of the graphical representation.

18. A system comprising:
data processing hardware; and
memory hardware in communication with the data processing hardware, the memory hardware storing instructions that when executed on the data processing hardware cause the data processing hardware to perform operations comprising:
obtaining a use case including a task;
identifying a multi-agent system for performing the task;
generating a graphical representation of the multi-agent system, wherein the graphical representation includes relational indicators regarding the multi-agent system;
obtaining an input interaction that is directed to the graphical representation of the multi-agent system; and
updating the graphical representation based on the input interaction.

19. The system of claim 18, wherein the use case is associated with one or more artificial intelligence (AI) agents, each respective AI agent associated with a respective one or more tools.

20. A computer-readable medium having instructions that, when executed by data processing hardware, causes the data processing hardware to perform operations comprising:
obtaining a use case including a task;
identifying a multi-agent system for performing the task;
generating a graphical representation of the multi-agent system, wherein the graphical representation includes relational indicators regarding the multi-agent system;
obtaining an input interaction that is directed to the graphical representation of the multi-agent system; and
updating the graphical representation based on the input interaction.
